(19) United States
(12) Patent Application Publication
(10) Pub. No.: US 2004/0181492 A1
(43) Pub. Date: Sep. 16, 2004

(54) Method and apparatus for managing utility usage

(76) Inventors: Andrew Rybakowski, Toronto (CA); Boris Sedlasek, Mississauga (CA); Kewei Zhang, North York (CA)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/799,480

(22) Filed: Mar. 11, 2004

Related U.S. Application Data
(60) Provisional application No. 60/454,198, filed on Mar. 12, 2003.

(51) Int. Cl. G06F 17/60

(52) U.S. Cl. 705/63

(57) ABSTRACT

A method and a system of managing utility cost of an entity are disclosed. The method and system include the functionality of measuring utility usage of the entity during a defined time interval and obtaining unit utility pricing information that is established during the coincident time interval. The method and system also matches the utility usage in a defined time interval with the utility per unit price in the same time interval for the purpose of calculating the utility cost in that time interval as well as the running total of the utility cost. Specifically, the running total is the sum of the utility costs measured for each time interval over a number of time intervals occurring during the day. The method and system further include capabilities of affecting the utility consumption of the entity based on the utility cost as measured in an interval as well as the running total utility cost.

### FIELD OF THE INVENTION

The present invention generally relates to methods and systems for utility usage monitoring and management.

### BACKGROUND

As deregulation of the energy markets (e.g., gas, electricity, etc.) unfolds, the traditional utility industry is transforming into a competition-oriented energy and service industry. This deregulation process has brought new market participants into the markets and caused upgrades of new technologies to accommodate these new participants. The new technologies enable real-time utility trading, monitoring of rapid swings in utility prices and usage, and provide alarm signals which can be integrated with energy control systems. In order for utility consumers to effectively manage the cost of their utility consumption, the consumers need to monitor the fast-changing pricing and usage information and modify their consumption levels accordingly.

Prior art systems include consumption monitoring and even reporting functionality. For instance, the CE-MON Automatic Meter Reading (“AMR”) system of the E-MON® Corporation provides charts and also generates itemized electric bills. However, the CE-MON AMR system neither monitors changes in utility prices nor calculates the cost of utility consumption based on real time fluctuating utility prices. The CE-MON AMR also lacks the capabilities to allow its users to quickly adjust their utility consumption patterns. As will be discussed in more detail below, an improved method and system is disclosed to address at least the mentioned shortcomings above.

### SUMMARY

A method and a system of managing utility cost of an entity are disclosed. The method and system include the functionality of measuring utility usage and utility prices during the same time interval in order to calculate the cost of the utility used in that time interval. For example, if the energy consumed in a specific time interval (i.e., 10:00 am to 10:05 am) was 100 kWh and if the cost of electricity during that same time interval was 6 cents per kWh, then the cost of the energy used during that time interval would be $6.00. The length of the time interval is typically determined by the energy market. The method and system also identify the running total which is based on the sum of the utility costs for a number of time intervals. The utility cost for a defined time interval is the utility usage measured in the time interval, multiplied by the unit utility price in the same time interval. The method and system further include capabilities of affecting the utility consumption of the entity based on the running total, the cost calculated in a defined time interval, utility price spikes, and peak utility demand.

In one embodiment, the present invention provides a method of managing utility cost of an entity. The method includes, for each of a plurality of time intervals: (a) measuring utility usage of the entity during a time interval, (b) obtaining unit utility price for the entity whereby the pricing information was established during the time interval, and (c) establishing a utility cost for the time interval where the cost is the product of the unit utility price and the utility usage. The method then calculates a cumulative total of the utility cost based on costs calculated for each of the plurality of intervals. Finally, the method affects utility consumption of the entity based on the cumulative total so as to manage the utility cost of the entity.

In another embodiment, the invention provides a system of managing utility cost of an entity. The system includes a plurality of meter profilers which obtain utility usage of the entity measured during a defined time interval. The system also includes a server, which is coupled to the plurality of the meter profilers via a communication device and coupled to an independent market operator. The server obtains unit utility pricing information which the independent market operator establishes for defined time intervals. The server correlates each time interval for the utility usage data with a corresponding time intervals for the utility price data. The server also establishes a utility cost for each time interval based on the utility usage measured during the interval and the utility price during the same interval and a running total of the utility cost based on the utility cost measured over a defined number of time intervals. Finally, the server affects utility consumption of the entity based on the running total.

The foregoing and other embodiments and aspects of the method and system will become apparent to those skilled in the art in view of the subsequent detailed description, the appended claims, and the accompanying figures.

### BRIEF DESCRIPTION OF THE FIGURES

FIG. 1 is a block diagram illustrating an exemplary utility usage management system;

FIG. 2 is a block diagram illustrating an exemplary computer system;

FIG. 3 is a flow chart illustrating an exemplary process that a server in an exemplary utility usage management system follows;

FIG. 4 is a flow chart illustrating an exemplary process that a server in an exemplary utility usage management system follows when the user-defined criteria include a threshold; and

FIG. 5 is a block diagram illustrating an exemplary meter profiler.

### DETAILED DESCRIPTION

A method and apparatus for managing utility usage is described. In the following description, numerous specific details are set forth, such as Cyclic Redundancy Check (CRC), Electronics Industry Association (“EIA”) standards, etc. in order to provide a thorough understanding of the present invention. However, it will be apparent to one of ordinary skill in the art that the invention may be practiced without these particular details. In other instances, well-known elements and theories such as CRC, Personal Digital Assistant (PDA) the EIA standards, etc. have not been discussed in special details in order to avoid obscuring the present invention.

Throughout the disclosure, a browser broadly refers to a software application that locates Internet web pages and presents a user of the browser multimedia information, including text, still images, sound, and video.

A provisional application for the invention was filed on Mar. 12, 2003 and is incorporated herein by reference.

Overview

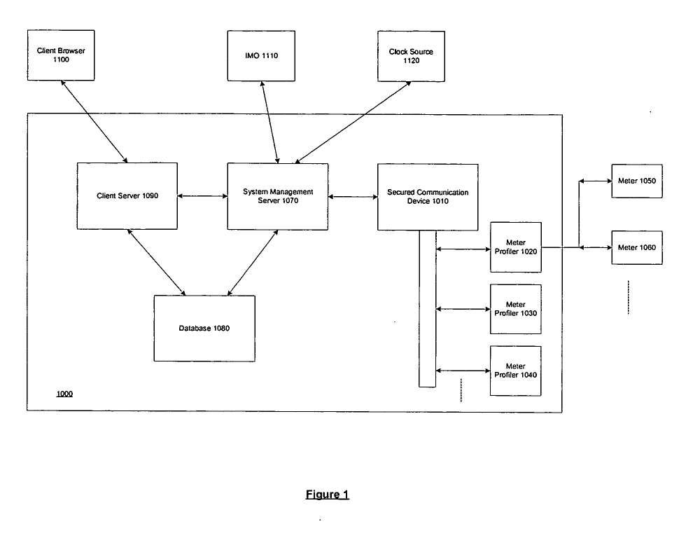

FIG. 1 demonstrates a block diagram of one embodiment of utility usage management system 1000. The system includes secured communication device 1010, a number of meter profilers, such as meter profilers 1020, 1030, and 1040, system management server 1070, client server 1090 and database 1080. The meter profilers track, maintain, and transmit usage information from multiple utility meters, such as meters 1050 and 1060, to secured communication device 1010. An exemplary meter can be, but without limitation, an electricity meter, a gas meter, or a water meter.

In one embodiment, in response to the requests of system management server 1070 for utility usage information (e.g., information regarding the usage of a particular meter, the usage of a particular group of meters, etc.), the meter profilers transmit the requested information via secured communication device 1010 to the server. Alternatively, without any requests from system management server 1070, the meter profilers automatically provide the server with a set of utility usage information at certain time intervals. System management server 1070 time stamps the usage information by recording the time that it received the information. In another implementation, the meter profilers time stamp the utility usage information as they receive the information from the meters. The meter profilers then transmit both the usage information and the corresponding time stamp information to system management server 1070. Subsequent paragraphs will provide exemplary implementations of the meter profilers.

An exemplary embodiment of secured communication device 1010 responds to requests from and transmits data to a limited set of systems, such as, without limitation, system management server 1070 and meter profilers 1020, 1030, and 1040. This prevents third party systems from tampering with data that utility usage management system 1000 comes in contact with. A person of ordinary skill in the art should recognize that secured communication device 1010 can include other security measures without exceeding the scope of utility usage management system 1000. For example, one embodiment of secured communication device 1010 authenticates the identities of system management server 1070 and the meter profilers before either responding to requests from or sending data to them.

After system management server 1070 obtains the utility usage information and the corresponding time stamp information, the server organizes and stores the information in database 1080. In the following discussions, system management server 1070 contains the intelligence of managing database 1080. However, it should be apparent to one with ordinary skill in the art to include the database management intelligence in database 1080 without exceeding the scope of utility usage management system 1000.

System management server 1070 also obtains utility pricing information and time stamp information (i.e., the time interval that the pricing information is established) from Independent Market Operators (hereinafter “IMO”) 1110. For example, in Ontario, Canada, the IMO is a government independent non-profit company set up to ensure the reliability of electricity and a fair and competitive marketplace. The IMO administers the wholesale electricity markets and sets the spot price. IMO 1110 sets different unit utility (e.g., electricity, gas, and water) prices according to market demand and supply. As the market demand and supply fluctuates, so do the unit utility prices. One embodiment of system management server 1070 queries IMO 1110 at certain time intervals for the latest pricing information and the time such pricing information is established. In an alternative embodiment, IMO 1110 broadcasts the pricing and the corresponding time stamp information to interested parties, such as system management server 1070, at certain time intervals without having received express inquiries.

System management server 1070 is also capable of assessing the cost effectiveness of utility usage by an entity (or a person) by processing the aforementioned utility usage information, unit utility pricing information, and time stamp information from both the meter profilers and IMO 1110. To further ensure the accuracy of such an assessment, an exemplary embodiment of system management server 1070 synchronizes its internal clock to the reference clock from clock source 1120 at certain time intervals. Clock source 1120 can include, but is not limited to, the atomic clock in Boulder, Colo. administered by the US. National Institute of Standards, and Technology. Subsequent paragraphs will provide examples to further demonstrate these processing capabilities.

In one embodiment of utility usage management system 1000, a user of the system can obtain any of the stored information from database 1080 via a client-server network. Specifically, the user can retrieve the stored information by issuing a request through client browser 1100 to client server 1090. The server is then responsible for relaying the information from database 1080 to the client browser. Alternatively, the user may receive the stored information through client browser 1100 or a paging/messaging system from client server 1090 without expressly requesting the information (i.e., utility pricing and peak load alarms when pre-selected threshold levels have been exceeded). In this alternative implementation, client server 1090 transmits the information based on some predetermined parameters (e.g., type of information to transmit, frequency of transmission, etc.). Subsequent paragraphs will provide examples to illustrate the interactions between the user and utility usage management system 1000.

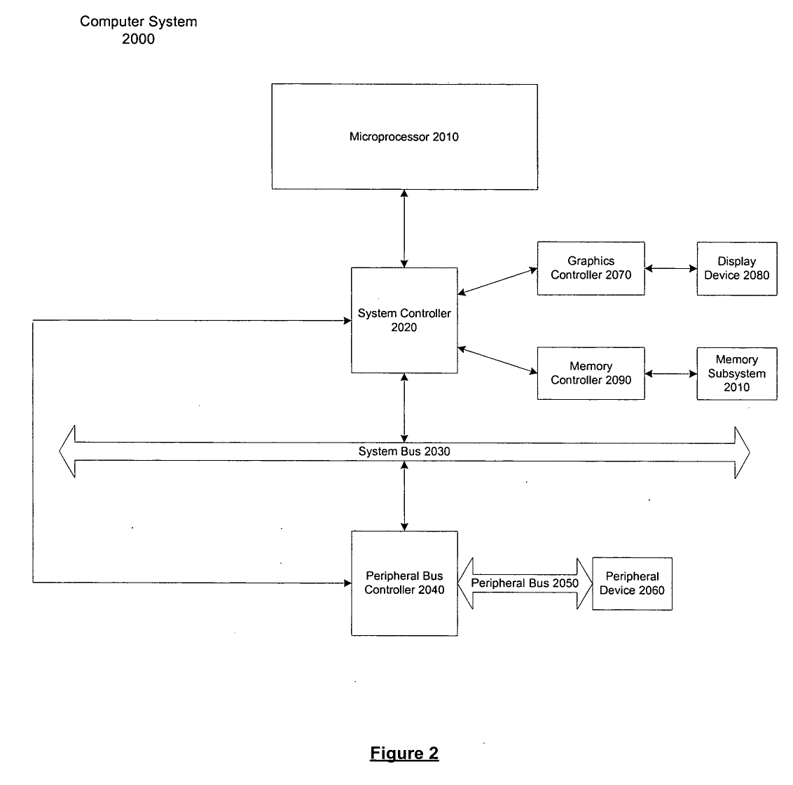

Exemplary embodiments of system management server 1070 and client server 1090 include, without limitation, customized electronic apparatuses and general-purpose computer systems. Specifically, an electronic apparatus may be specifically designed to include certain application specific devices and embedded software that provide the functionality of the servers mentioned above. Alternatively, a general-purpose computer system, such as computer system 2000 as shown in FIG. 2, installed with a general-purpose operating system (e.g., Intel-based operating system, Unix-based operating system, etc.) and application software can also provide the functionality of the servers.

The system architecture of computer system 2000 includes one or more microprocessors, such as microprocessor 2010, controllers, such as system controller 2020, graphics controller 2070, memory controller 2090, and peripheral bus controller 2040, display device 2080, memory subsystem 2010, and peripheral device 2060. The exemplary computer system 2000 also includes system bus 2030 and peripheral bus 2050. In one embodiment of computer system 2000, microprocessor 2010 is coupled to system controller 2020. System controller 2020 is further coupled to memory subsystem 2010 via memory controller 2090 and coupled to display device 2080 through graphics controller 2070. Coupled to peripheral bus 2050 are peripheral bus controller 2040 and peripheral device 2060. Some examples of peripheral device 2060 are, without limitation, a mass storage device (e.g., hard disk), an alphanumeric input device (e.g., keyboard), other input device (e.g., mouse, microphone, biometric sensors, etc.), and a Universal Serial Bus (“USB”) device.

Moreover, in one embodiment of computer system 2000, system controller 2020 has a direct channel of communication with peripheral bus controller 2040. The described components of computer system 2000 perform their conventional functions well known in the art. It should have been apparent to one ordinarily skilled in the art that computer system 2000 may have more or less components than the illustrated system in FIG. 2. For example, one having ordinary skill in the art may divide functionality of a single illustrated component across various devices (e.g., some functionality of memory controller 2090 may go into memory subsystem 2010) or integrate functionality of multiple illustrated components into a single device (e.g., the functionality of system controller 2020 and peripheral bus controller 2040 may be combined into one controller).

The software instructions that are installed on computer system 2000 are generally stored in peripheral device 2060. During the execution of these instructions, computer system 2000 may temporarily store the instructions in memory subsystem 2010 or in an on-chip memory subsystem (e.g., cache) of microprocessor 2010. In an alternative embodiment, the software for performing the requested tasks is stored and executed via the internet as is commonly seen in on-line gambling or on-line mortgage calculation applications.

System Management Server

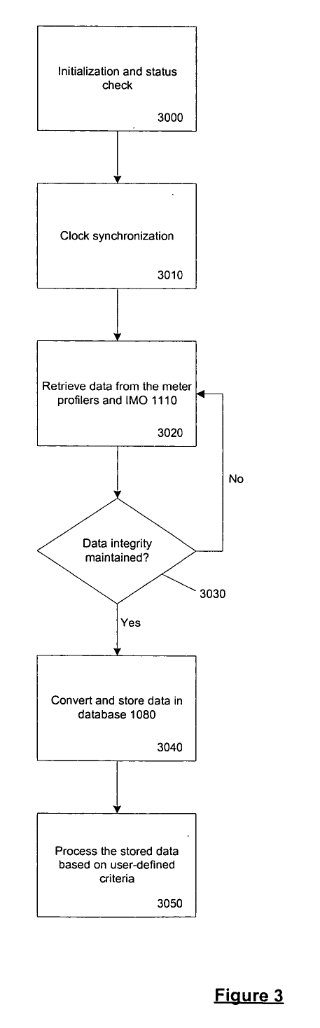

FIG. 3 illustrates an exemplary process that system management server 1070 follows. Specifically, in block 3000, system management server 1070 initializes and checks the operating status of various components in utility usage management system 1000. For example, system management server 1070 sends instructions to meter profilers 1020, 1030, and 1040 via secured communication device 1010 to initialize (this includes synchronizing the clocks) the meter profilers and also to verify the operating status of the meter profilers. If any of the meter profilers, such as metro profiler 1020, indicates an error during this status check, one embodiment of system management server 1070 has the option of either resetting or turning off the failing meter profiler.

In block 3010, system management server 1070 synchronizes its internal clock to the reference clock of clock source 1120. This clock synchronization can occur either at a predetermined time interval (e.g., every five minutes) or at a user-defined time interval (i.e., the user can specify how frequently the synchronization should occur). In block 3020, system management server 1070 retrieves data from IMO 1110 and the meter profilers that are attached to secured communication device 1010. One embodiment of system management server 1070 may expressly request, via secured communication device 1010, the utility usage information that meter profilers 1020, 1030, and 1040 have captured. Alternatively, system management server 1070 may passively obtain the utility usage information (i.e., the meter profilers send the information to the server at certain time intervals without any requests for such information.

In one implementation, meter profilers 1020, 1030, and 1040 maintain utility usage information from the meters that they monitor until system management server 1070 successfully retrieves the information. With its own internal clock, system management server 1070 time stamps the utility usage information as it receives the information. As discussed above, in an alternative embodiment of utility usage management system 1000, the meter profilers generate the time stamp information that corresponds to the utility usage information. In such an embodiment, it should be apparent to one with ordinary skill in the art to synchronize the clock that the meter profilers rely on to the reference clock of clock source 1120 via the system management server 1070 clock.

Also in block 3020, system management server 1070 obtains the unit utility pricing information and the corresponding time stamp information from IMO 1110. The server either expressly retrieves the information from IMO 1110 or passively receives the information at certain time intervals.

To maintain data integrity, system management server 1070 verifies the retrieved data in block 3030. For example, one embodiment of system management server 1070 applies a CRC technique to detect transmission errors. If the server detects an error, the server discards the erroneous data and requests a re-transmission of the data. Otherwise, system management server 1070 converts the retrieved data and stores the converted data in database 1080 in block 3040. It should be apparent to a person with ordinary skill in the art to implement system management server 1070 with other error checking techniques or error recovery techniques without exceeding the scope of utility usage management system 1000.

As an illustration, system management server 1070 organizes the retrieved data according to the time stamps and the source of the data in block 3040. Additionally, each device 1010 and each meter profiler device 1020 has a unique identifier. A sample format is as follows:

from IMO 1110, Jan. 01, 03, 12:30 PM, interval 12:25-12:30 PM $0.11/Kilowatt-hour,

from meter 1050, Jan. 01, 03, 12:30 PM, interval 12:25-12:30 PM, 1296 Kilowatt-hour . . .

A person with ordinary skill in the art can organize the retrieved data in many other formats than the one shown above without exceeding the scope of utility usage management system 1000.

After the retrieved data are formatted, one embodiment of system management server 1070 stores all of the formatted data (i.e., source, date, time, and price or usage) in database 1080. An alternative embodiment of the server selectively stores the formatted data. For example, the server may store all the date, time, price, and usage information from the same source in designated locations in database 1080 but does not explicitly store the source information (though the source information can be implied because of its association to the specific database locations). Another embodiment of the server may store just the time, price, and usage information from the same source on the same date in designated locations in database 1080.

A user of an exemplary embodiment of utility usage management system 1000 specifies a set of criteria via client browser 1100 for system management server 1070 to follow. For example, the criteria can cause the server to report to the user on the utility usage of an entity and the associated cost for such usage every five minutes. Alternatively, the criteria can cause the server to perform certain tasks (e.g., alerting a user or automatically adjusting the utility usage pattern of an entity) after reaching a predetermined threshold. Through client browser 1100, the user also has the flexibility to modify the criteria.

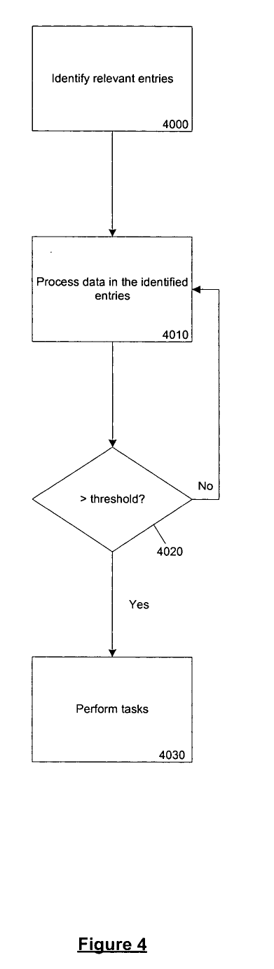

In block 3050, utility usage management system 1000 processes the stored data based on the user-defined criteria as discussed above. FIG. 4 illustrates one process that one embodiment of system management server 1070 follows when the user-defined criteria include a threshold. Suppose utility usage management system 1000 monitors the utility usage of Company X, and database 1080 contains the following entries of data:

| Source | Date | Time Interval | Price ($/kWh) |
|---|---|---|---|
| IMO 1110 | Jan. 01, 2003 | 5:55-6:00 AM | $0.055 |
| IMO 1110 | Jan. 01, 2003 | 6:00-6:05 AM | $0.065 |
| IMO 1110 | Jan. 01, 2003 | 6:05-6:10 AM | $0.045 |
| IMO 1110 | Jan. 01, 2003 | 6:10-6:15 AM | $0.050 |
| Source | Date | Time Interval | KWh |
| Meter 1050 | Jan. 01, 2003 | 5.55-6:00 AM | 50 |
| Meter 1050 | Jan. 01, 2003 | 6:00-6:05 AM | 75 |
| Meter 1050 | Jan. 01, 2003 | 6:05-6:10 AM | 65 |
| Meter 1050 | Jan. 01, 2003 | 6:10-6:15 AM | 70 |

Each of the pricing information above indicates the cost per kilowatt-hour (e.g., $0.055 represents the cost per kilowatt hour from 5:55 to 6:00 am). Each of the usage information indicates the kilowatt-hour usage of Company X (meter 1050) in a 5 minute interval (e.g., 50 represents the kilowatt-hour usage between 5:55 to 6:00 am). The pricing information and the usage information shown in the charts is updated every five minutes. It should be apparent to one with ordinary skill in the art to implement utility usage management system 1000 without the specific details shown above. For example, system management server 1070 can format and store the pricing information at one time interval (e.g., every four minutes) but format and store the usage information at another time interval (e.g., every six minutes)—However, for practical and analytical use of the pricing and usage information (e.g. to calculate cost per time interval), the time intervals are the same length and are coincident.

In addition, suppose the user-defined criteria include a $500.00 threshold for the utility daily cumulative usage cost of Company X and a five minute “refresh” rate for system management server 1070 (i.e., system management server 1070 performs the cost analyses every five minutes). In block 4000, system management server 1070 identifies relevant IMO and meter entries with date and time stamp information that corresponds to one another. As an illustration, the IMO utility price entry with Jan. 1, 2003 and interval 6:10-6:15 AM information corresponds to the meter utility usage entry with Jan. 1, 2003 and interval 6:10-6:15 AM information.

After system management server 1070 retrieves the pricing and the usage information from the identified entries, the server performs the following cost calculations every five minutes in block 4010 for each 5 minute interval. The daily energy costₜₒₜₐₗ (running total) is the cumulative cost for the day which starts at a designated time in the day (typically midnight) and ends at some designated time (typically the following midnight). The daily energy costₜₒₜₐₗ could be calculated for any period during the day.

(1) cost (6:00 AM)=$0.055*50

(2) cost (6:05 AM)=$0.065*75

(3) cost (6:10 AM)=$0.045*65.

(4) cost (6:15 AM)=$0.050*70

(5) daily energy costₜₒₜₐₗ=cost (midnight-00:05 AM)+ . . . +cost (5:55-6:00 AM)+cost (6:00-6:05 AM)+cost (6:05-6:10 AM)+cost (6:10-6:15 AM)+ . . . +cost (23:55-24:00 pm)

If system management server 1070 determines that daily costₜₒₜₐₗ exceeds a user-defined threshold (e.g., $500 in this example) at 5:35 PM, in block 4020, it proceeds to perform certain tasks in block 4030. Some tasks include, without limitation, alerting individuals, at 5:35 PM, that are responsible for monitoring the utility consumption of Company X, or automatically adjusting utility consumption of Company X (e.g., dimming lights, adjusting the thermostat of either a cooling system or a heating system, adjusting water flow, etc.). System management server 1070 can alert the individuals either via client browser 1100 e-mail or via another output device. Some examples of this output device are, without limitation, a pager, a cellular phone, a PDA, a telephonic device, and speakers.

Meter Profilers

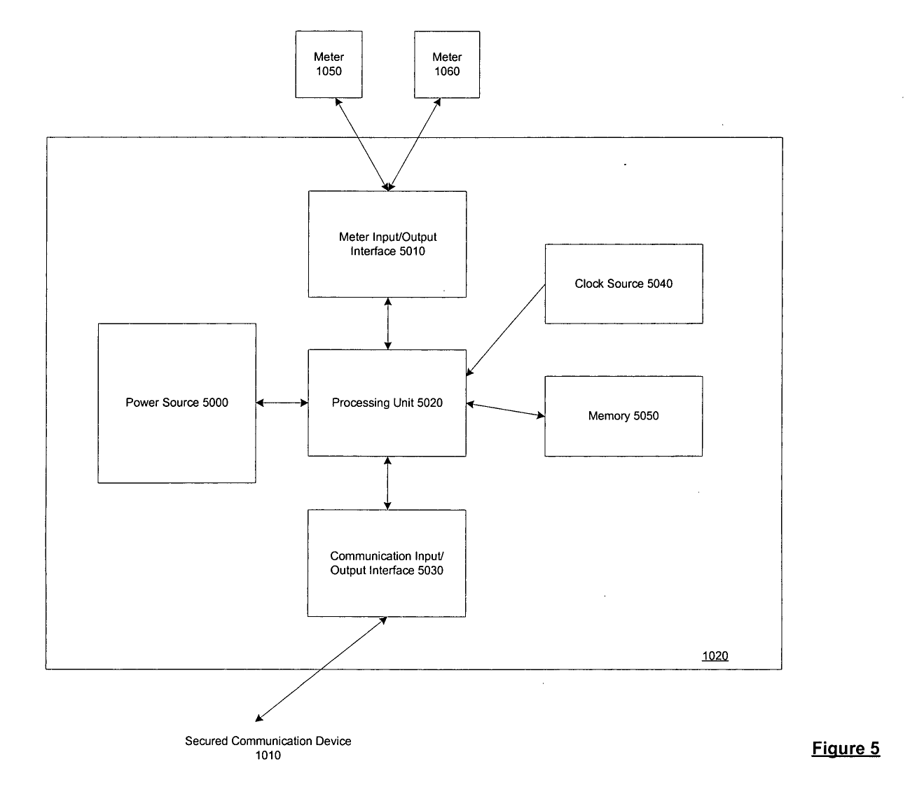

FIG. 5 illustrates one exemplary embodiment of a meter profiler, such as meter profiler 1020. Meter profiler 1020 includes power source 5000, meter input/output interface 5010, processing unit 5020, communication input/output interface 5030, clock source 5040, and memory 5050. Power source 5000 can either be an internal or external source. One embodiment of meter input/output interface 5010 includes circuitry to protect processing unit 5020 from voltage surges. The interface converts and relays signals that are representative of utility usage information from meters, such as meter 1050 and 1060, to processing unit 5020. Communication input/output interface 5030 facilitates communication between processing unit 5020 and secured communication device 1010. One example of the interface adopts the EIA RS485 standard. Another example of the interface adopts a wireless standard. Clock source 5040 can be adjusted to synchronize with an external reference clock.

An exemplary embodiment of processing unit 5020 executes instructions that are stored in memory 5050 to carry out certain tasks. Some examples include, without limitation, collecting, time stamping, storing, managing, and transmitting utility usage information, communicating with secured communication device 1010 via communication input/output interface 5030, communicating with meters 1050 and 1060 via meter input/output interface 5010, performing error checking algorithms, and responding to data (e.g., requests for utility usage information, instructions to initialize a meter profiler, reference clock information for clock source 5040 to synchronize to, etc.) that come through secured communication device 1010. In addition to the instructions, memory 5050 may also store utility usage information and the corresponding time stamp information.

The various embodiments described above should be considered as merely illustrative of the present invention and not in limitation thereof. They are not intended to be exhaustive or to limit the invention to the forms disclosed. Those skilled in the art will readily appreciate that still other variations and modifications may be practiced without departing from the general spirit of the invention set forth herein. Therefore, it is intended that the present invention be defined by the claims which follow:

1. A method of managing utility cost of an entity, comprising:
(a) measuring utility usage of the entity during a time interval;
(b) obtaining unit utility price for said entity, the pricing information established during said time interval;
(c) establishing a utility cost for said time interval where the cost is the product of said unit utility price and said utility usage;
(d) repeating steps (a) to (c) for a plurality of time intervals; and
(e) calculating a cumulative total of the utility cost based on costs calculated for each of said plurality of intervals; and
(f) affecting utility consumption of the entity based on the cumulative total to manage the utility cost of the entity.

2. The method of claim 1, wherein said cumulative total affecting the utility consumption is based on the cost in one or more time intervals.

3. The method of claim 1, further comprising:
synchronizing, with a common reference clock, the clock that provides timing for the measurement of utility usage during a specific time interval and the collection of utility price data for the same time interval; and
ensuring that the time interval for the utility price directly corresponds, in time and duration, to the time interval for the measured utility usage.

4. The method of claim 1, further comprising:
verifying the utility usage is from a known measuring device.

5. The method of claim 3, further comprising:
verifying the utility usage is free of communication errors.

6. The method of claim 1, further comprising:
automatically adjusting the utility consumption if the running total or cost for a specific time interval reaches a threshold cost value.

7. The method of claim 1, further comprising:
automatically alerting an operator of the entity if the running total or cost in a specific time interval reaches a threshold cost value.

8. The method of claim 1, wherein the time interval for measuring utility usage is less than, equal to, or greater than five minutes.

9. The method of claim 1, wherein the time interval for measuring the utility price is less than, equal to, or greater than five minutes.

10. The method of claim 1, further comprising:
providing an interface for an operator of the entity to define parameters that affect the managing of the utility usage and cost.

11. The method of claim 1, wherein the parameters include the frequency of measuring the utility usage and establishing the running cost.

12. The method of claim 9, wherein the parameters include threshold load, electricity price, power factor, temperature, time period.

13. A system of managing utility cost of an entity, comprising:
a plurality of meter profilers which obtain utility usage of the entity measured during a defined time interval;
a server, coupled to the plurality of the meter profilers via a communication device and coupled to an independent market operator, wherein the server
obtains unit utility pricing information which the independent market operator establishes for defined time intervals;
correlates each time interval for the utility usage data with a corresponding time intervals for the utility price data;
establishes a utility cost for each time interval based on the utility usage measured during the interval and the utility price during the same interval;
establishes a running total of the utility cost based on the utility cost measured over a defined number of time intervals; and
affects utility consumption of the entity based on the running total.

14. The system of claim 13, wherein the server affects utility consumption of the entity based on cost in a particular time interval.

15. The system of claim 13, wherein the server further synchronizes the clocks in the plurality of the meter profilers with a common reference (e.g., national standard) clock signal.

16. The system of claim 15, wherein the time interval for the utility usage is coincident with the time interval for the utility price.

17. The system of claim 15, wherein the server further verifies that the utility usage is from the plurality of the meter profilers.

18. The system of claim 17, wherein the server further verifies that the utility usage is free of communication errors.

19. The system of claim 13, wherein the server automatically adjusts the utility consumption if the running total reaches a threshold cost value or if the utility cost in a time interval reaches a threshold cost value.

20. The system of claim 13, wherein the server automatically alerts an operator of the entity if the running total reaches a threshold cost value or if the utility cost in a time interval reaches a threshold cost value.

21. The system of claim 13, wherein the time interval for measuring utility usage is less than, equal to, or greater than five minutes.

22. The system of claim 13, wherein the time interval for measuring the utility price is less than, equal to, or greater than five minutes.

23. The system of claim 13, further includes a client server, coupled to the server, wherein the client server provides an interface for an operator of the entity to define parameters for the system to manage the utility cost.

24. The system of claim 22, wherein the parameters include the frequency for the plurality of the meter profilers to obtain the utility usage.

25. The system of claim 24, wherein the parameters include the frequency for the server to obtain the utility unit price information.

26. The system of claim 24, wherein the parameters include the frequency for the server to establish the running total.

27. The system of claim 24, wherein the parameters include the frequency for the server to establish the cost for each interval.

28. The system of claim 24, wherein the parameters include a threshold cost value.
